(19) United States
(12) Patent Application Publication
(10) Pub. No.: US 2024/0016190 A1
(43) Pub. Date: Jan. 18, 2024

(54) ROXBURGH ROSE AND COIX SEEDS COMPOSITE BEVERAGE AND PREPARATION METHOD THEREOF

(71) Applicant: Guizhou University, Guiyang (CN)

(72) Inventors: Laping HE, Guiyang (CN); Cuiqin LI, Guiyang (CN); Xueyi TIAN, Guiyang (CN)

(21) Appl. No.: 17/982,584

(22) Filed: Nov. 8, 2022

(30) Foreign Application Priority Data
Jul. 15, 2022 (CN) 202210831194.4

(51) Int. Cl. A23L 2/38; A23L 2/72; A23L 2/84

(52) U.S. Cl. CPC A23L 2/382; A23L 2/72; A23L 2/84

(57) ABSTRACT

Disclosed are a roxburgh rose and Coix seeds composite beverage and a preparation method thereof, belonging to the technical field of food processing. The preparation method includes: heating Coix seeds pulp for gelatinization, followed by adding alpha-amylase (α-amylase) for liquefaction, then adding saccharifying enzyme for saccharification to obtain Coix seeds enzymatic hydrolysate; then using Coix seeds enzymatic hydrolysate and roxburgh rose juice as raw materials, carrying out staged fermentation with Coriolus versicolor and Lactobacillus plantarum to obtain a fermentation broth, followed by homogenizing and filtering, centrifuging, sterilizing to obtain a new type of natural fermented beverage with aroma of roxburgh rose fruit, Coix seed, Coriolus versicolor-specific mushroom flavor and lactic acid fermentation flavor.

### CROSS-REFERENCE TO RELATED APPLICATIONS

This application claims priority to Chinese Patent Application No. 202210831194.4, filed on Jul. 15, 2022, the contents of which are hereby incorporated by reference.

### TECHNICAL FIELD

The present application belongs to the technical field of food processing, and particularly relates to a roxburgh rose and Coix seeds composite beverage and a preparation method thereof.

### BACKGROUND

Coriolus, also known as Coriolus versicolor, Trametes versicolor and Polyporus versicolor, etc., belongs to the genus Polystictus in the family Polyporaceae of Basidiomycotina. Studies have shown that Coriolus versicolor has a variety of physiological activities, such as anti-cancer, immune modulation, and hepatitis treatment. Glycopeptides isolated from mycelium of Coriolus versicolor have been confirmed to be major active substances of Coriolus versicolor, and Coriolus versicolor polysaccharides are confirmed to have strong antioxidant activity and significant scavenging effects on superoxide anion radicals and 2,2-diphenyl-1-picrylhydrazyl (DPPH) radicals.

Roxburgh rose (Rosa roxburghii Tratt.) belongs to the Rosa genus of Rosaceae family, whose fruit is almost spherical berries with small thorns around the fruit body, so the roxburgh rose is also known as “prickly pear” in China. Roxburgh rose ripens in August-October, with fruit bearing an orange-yellow epicarp, brittle fruit, strong fruit aroma, sour and astringent flesh, as well as rich nutrients; roxburgh rose contains a particular high content of vitamin C, with 100 grams (g) of fresh fruit containing 2,200-2,500 milligrams (mg) of vitamin C, winning the fruit a reputation of “king fruit of vitamin C”. The fruit of roxburgh rose is safe to be eaten directly, but most people cannot afford to eat fresh roxburgh rose directly due to its astringent taste; therefore it is processed into roxburgh rose juice, dried roxburgh rose fruit, roxburgh rose fruit wine and other products so as to be consumed with rather soft taste.

As a typical representative of medicine-food ingredients, Coix seed, a good food medicine also known as Job's Tear, Grass Pearl, Six Grain, Bodhi Pearl, is the seed embryo of Coix lacryma-jobi and can be used for dietotherapy. Coix seed is reputed as “the first of all cereals in the world” because of its high nutritional value, including protein, polysaccharide, minerals, starch, fat and other nutritional components; such a functional material for both food and medicine is receiving growing attention across the world.

The roxburgh rose with rich vitamin yet less protein, and roxburgh rose containing high content of protein and starch, are complementary in nutrition and can be combined together to achieve a better performance; the two materials after simply combination usually result in a poor taste with no core competitiveness as the nutritional value of the product cannot be well and effectively utilized. Therefore, there is an urgent need to develop a new preparation method to overcome defects and utilize them as valuable resources.

### SUMMARY

In order to solve the above problems in the prior art, the present application provides a roxburgh rose and Coix seeds composite beverage and a preparation method thereof.

To achieve the above objectives, the present application provides the following technical scheme:
a preparation method for preparing a roxburgh rose and Coix seeds composite beverage, including: heating Coix seeds pulp for gelatinization, followed by adding alpha-amylase (α-amylase) for liquefaction, then adding saccharifying enzyme for saccharification to obtain Coix seeds enzymatic hydrolysate; mixing the Coix seeds enzymatic hydrolysate with roxburgh rose juice, followed by adding with sucrose to obtain fermentation substrate; then inoculating Coriolus versicolor seed liquid into the fermentation substrate for fermentation, and inoculating Lactobacillus plantarum seed liquid into the fermentation substrate for further fermentation, obtaining a fermented broth, subjecting the fermented broth to homogenizing and dispersing, ultrasonicating, filtering to remove the precipitation, centrifuging and sterilizing to obtain the roxburgh rose and Coix seeds composite beverage.

Homogenizing is arranged to crush the mycelia of Coriolus versicolor and ultrasonicating can dissolve nutrients of Coriolus versicolor into the beverage as much as possible.

Optionally, the Coix seeds pulp contains Coix seeds to water in a mass ratio of 1:15; the heating is carried out at 85-95 degree Celsius (° C.) for gelatinization of 15-25 minutes (min), rather optionally, the heating is carried out at 90° C. for 20 min.

Optionally, the α-amylase is added in an amount of 200 micrograms (U/g); the liquefaction is carried out at 85-95° C. for a duration of 40-50 min, preferably 90° C. for 40-50 min; the saccharifying enzyme is added in an amount of 300 U/g; and the saccharification is carried out at 60-70° C. for a duration of 70-90 min, preferably at 65° C. for 80 min.

Optionally, the Coix seeds enzymatic hydrolysate is in a volume ratio of 7:(2-4), preferably 7:3, to the roxburgh rose juice; and the sucrose added accounts for 1-9 percent (%) of that total mass of the Coix seeds enzymatic hydrolysate and the roxburgh rose juice.

Optionally, the Coriolus versicolor seed liquid is prepared as follows: inoculating Coriolus versicolor onto slant culture medium, and culturing the medium at 27° C. for 4-6 days under dark to obtain first-grade seeds; scraping 5-8 mycelia from the first-grade seeds in the slant culture medium into a second-grade seed liquid culture medium, culturing at 27° C. and 170 revolutions per minute (rpm) for 4-5 days to obtain a second-grade seed liquid; and homogenizing the second-grade seed liquid under aseptic condition for 5 s to obtain the Coriolus versicolor seed liquid.

Optionally, the Coriolus versicolor seed liquid inoculated into the fermentation substrate accounts for 3.5-4.5 weight percentage (wt %) of the fermentation substrate, and the fermentation is carried out at 25-30° C. for a duration of 1.5-2.5 days.

Optionally, the Lactobacillus plantarum seed liquid is prepared as follows: inoculating Lactobacillus plantarum into a liquid culture medium for 18 hours (h) to obtain activated seed liquid, then inoculating the activated seed liquid into a solid culture medium for secondary activation, selecting a single colony on the solid culture medium for liquid culture after the secondary activation to obtain the Lactobacillus plantarum seed liquid.

Optionally, the Lactobacillus plantarum seed liquid inoculated into the fermentation substrate accounts for 1-5 wt % of the fermentation substrate, and the further fermentation is carried out at 29-45° C. for a duration of 12-36 h.

Optionally, the mycelia in the Coriolus versicolor seed liquid are in an amount of 0.5-1 g/100 milliliters (mL); and the Lactobacillus plantarum seed liquid contains beneficial viable bacteria in a concentration of (1−9)*10⁸ colony-forming unit per milliliter (CFU/mL).

The present application also provides a roxburgh rose and Coix seeds composite beverage prepared by the preparation method.

Coriolus versicolor is one of the edible fungi that can be directly used as strains for fermentation and transformation. Raw materials fermented with edible fungi often obtain unique flavor and improved nutritional structure; moreover, the fermented broth fermented by edible fungi can still be further fermented by probiotics, which further transform macromolecular substances into easily absorbable micromolecules and newly generate some energy-supplying substances; the product is largely improved in terms of taste, flavor and functional substances of fermented broth after compound fermentation of edible fungi and probiotics, thus meeting people's demand for high-quality food.

Compared with the prior art, the application has the following beneficial effects:
the present application not only preserves the nutritional value of roxburgh rose and Coix seeds to the greatest extent, but also adds value to the raw materials of roxburgh rose and Coix seeds enzymatic hydrolysate through the compound fermentation of Coriolus versicolor and Lactobacillus plantarum LB12;
according to the present application, a staged fermentation is carried out using roxburgh rose juice and Coix seeds enzymatic hydrolysate as raw materials, and fungi Coriolus versicolor with extremely high nutritional value and probiotics Lactobacillus plantarum as fermentation strains, so that a fermented broth with sweet fruit flavor of roxburgh rose, sweet rice aroma of Coix seeds, in addition to unique mushroom flavor of Coriolus versicolor and lactic acid fermentation flavor, then a novel natural fermented beverage is obtained through homogenizing, filtering, centrifuging and sterilizing the fermented broth; the prepared beverage is a new type of fermented beverage with rich taste and bright yellow and clear color, with sweet and sour taste, unique and rich fermentation flavor; the prepared beverage boasts a certain ability to lower blood sugar, making it healthier to drink.

### BRIEF DESCRIPTION OF THE DRAWINGS

FIG. 1 illustrates polysaccharide contents and sensory scores of roxburgh rose and Coix seeds composite beverages obtained by fermenting with different inoculation amount of Lactobacillus plantarum LB12.

FIG. 2 shows sensory attributes of roxburgh rose and Coix seeds composite beverages obtained by fermenting with different inoculation amount of Lactobacillus plantarum LB12.

FIG. 3 shows contents of γ-aminobutyric acid (GABA) and vitamin C of roxburgh rose and Coix seeds composite beverages obtained fermenting with different inoculation amount of Lactobacillus plantarum LB12.

FIG. 4 shows the polysaccharide contents and sensory scores of roxburgh rose and Coix seeds composite beverages obtained after fermenting by Lactobacillus plantarum LB12 for different durations.

FIG. 5 shows the sensory attributes of roxburgh rose and Coix seeds composite beverages obtained after fermenting by Lactobacillus plantarum LB12 for different durations.

FIG. 6 shows the contents of GABA and vitamin C of roxburgh rose and Coix seeds composite beverages obtained after fermenting by Lactobacillus plantarum LB12 for different durations.

FIG. 7 shows the polysaccharide contents and sensory scores of roxburgh rose and Coix seeds composite beverages obtained after fermenting by Lactobacillus plantarum LB12 under different temperatures.

FIG. 8 shows the sensory attributes of roxburgh rose and Coix seeds composite beverages obtained after fermenting by Lactobacillus plantarum LB12 under different temperatures.

FIG. 9 shows the GABA and vitamin C contents of roxburgh rose and Coix seeds composite beverages obtained after fermenting by Lactobacillus plantarum LB12 under different temperatures.

FIG. 10 shows the polysaccharide contents and sensory scores of roxburgh rose-Coix seed compound beverages prepared with different sucrose addition.

FIG. 11 shows the sensory attributes of roxburgh rose and Coix seeds composite beverages with different sucrose addition.

FIG. 12 shows the GABA and vitamin C contents of roxburgh rose and Coix seeds compound beverages prepared with different sucrose addition.

FIG. 13 illustrates types and relative contents of volatile compounds detected in different fermentation stage of the roxburgh rose and Coix seeds composite beverage.

FIG. 14 shows tannin contents detected in different fermentation stage of the roxburgh rose and Coix seeds composite beverage.

FIG. 15 shows test results of in vitro hypoglycemic activity detected in different fermentation stages of the roxburgh rose and Coix seeds composite beverage.

FIG. 16 is a brief processing illustrating a preparation method of preparing a roxburgh rose and Coix seeds composite beverage according to one embodiment of the present application.

### DETAILED DESCRIPTION OF THE EMBODIMENTS

Now various exemplary embodiments of the present application will be described in detail. This detailed description should not be taken as a limitation of the present application, but should be understood as a more detailed description of some aspects, characteristics and embodiments of the present application. It should be understood that the terms mentioned in the present application are only used to describe specific embodiments, and are not used to limit the present application.

The following embodiments use high-temperature alpha-amylase (α-amylase) and saccharifying enzyme purchased from Jiangsu Ruiyang Biotechnology Co., Ltd., biological samples (Lactobacillus plantarum LB12 with preservation number of CCTCC M 2022948, Lactobacillus plantarum NR1-7 with preservation number of CCTCC M 20211541 and has been published in Isolation and screening of lactic acid bacteria with the ability to remove cholesterol and lower nitrite from cured beef and its fermentation performances by SONG Xiao-juan et al., on Science and Technology of Food Industry (Vol. 37, No. 09, 2011), the NR7 strains in this paper are Lactobacillus plantarum NR1-7, which the applicant promises to open to the public within 20 years from the application date; following embodiments also use bifidobacteria BZ11 with preservation number if CGMCC NO.10224, bifidobacteria BZ25 with preservation number of CGMCC NO.10225, Lactobacillus pentosus MT-4 with preservation number of CCTCC M 2016001, and Streptococcus thermophilus, where the biological samples are commercially available with viable count ≥10 billion colony-forming unit per milliliter (CFU/mL); the following embodiments adopt edible fungus Coriolus versicolor provided by the Edible Fungus Research Institute of Xishui County, Guizhou Province, and aroma-producing yeast and Saccharomyces cerevisiae purchased from Angel Yeast Co., Ltd.

Isolation and purification of Lactobacillus plantarum LB12:
using a traditional fermented Guizhou Kaili sour soup as a screening source, adding 25 milliliters (mL) sour soup into a triangle bottle containing 225 mL sterile peptone water (peptone 1 grams per liter (g/L), NaCl 0.85 g/L, Tween-80 1 mL/L), placing the triangle bottle on a shaking table for oscillation for 60 minutes (min), followed by standing for 10 min; taking 1 mL of supernatant to subject to 10 times gradient dilution, coating it on CaCO₃-MRS culture medium plate with appropriate dilution concentration, followed by anaerobic culture at 37 degree Celsius (° C.) for 48 hours (h), then selecting a single colony that producing calcium dissolving ring for further separation and purification; carrying out Gram staining on the single colony after purification, then selecting Gram-positive bacteria and enzyme-negative bacteria (directly add 10% H₂O₂ to the colony), and observing under microscope; separating pure strains for slant inoculation, followed by short-term preservation at 0-4° C., or long-term preservation at −80° C. with glycerol with a final concentration of 20%; see Table 1 for results of cellular morphology and physicochemical experiments of the obtained strain:

TABLE 1

| Experimental project | Result | Experimental project | Result | Experimental project | Result |
|---|---|---|---|---|---|
| cellular morphology | rhabditiform | gram stain | positive | oxidase | − |
| contact enzyme | − | | | | |

Acid production from carbohydrates (API 50CH)

| | | | | | |
|---|---|---|---|---|---|
| glycerol | − | mannitol | + | synanthrin | − |
| erythrinol | − | sorbitol | + | melezitose | + |
| L-arabinose | + | a-methyl-D-mannoside | + | raffinose | + |
| D-ribose | + | a-methyl-D-glucoside | − | starch | − |
| D-xylose | − | N-acetyl-glucosamine | + | glycogen | − |
| L-xylose | − | amygdalin | + | xylose fermentation | − |
| ribitol | − | arbutin | + | gentiobiose | + |
| β-methyl-D-xyloside | − | polychrom | + | D-turanose | − |
| D-galactose | + | salicin | + | D-Lysol | − |
| D-glucose | + | cellobiose | + | D-tagatose | − |
| D-fructose | + | maltose | + | D-fucose | − |
| D-mannose | + | lactose | + | D-arabinitol | − |
| L-sorbose | − | melibiose | + | L-arabinitol | − |
| L-rhamnose | + | sucrose | + | 2-keto-glucuronate | − |
| dulcitol | − | trehalose | + | L-fucose | − |
| inositol | − | D-arabinose | − | gluconate | − |

Note:
+ stands for positive, and − stands for negative.

Further detection of 16S rRNA gene sequence and pheS gene sequence is carried out, where the detection results are analyzed comprehensively with reference to Bergey's Manual of Determinative Bacteriology and related research papers of International Journal of Systematic and Evolutionary Microbiology, and the obtained strain is confirmed to be Lactobacillus plantarum, named Lactobacillus plantarum LB12.

The embodiments use Coriolus versicolor seed liquid prepared as follows: using an inoculation spatula to cut Coriolus versicolor seed blocks with a diameter of 2 micrometers (mm) and then inoculating them into slant medium (formula: 200 g potato, 20 g glucose, 2 g peptone, 2 g potassium dihydrogen phosphate, 1 g magnesium sulfate heptahydrate, 1,000 mL water, 20 g agar, pH natural), incubating them for 5 days at 27° C. under light-proof conditions to obtain primary seeds; scraping 6 blocks of mycelia from the primary seeds in the slant medium (as small as possible, visible to the naked eye) into a secondary seed liquid medium (formula: 200 g potato, g glucose, 2 g peptone, 2 g potassium dihydrogen phosphate, 1 g magnesium sulfate heptahydrate, 1000 mL water, pH natural) and culturing at 27° C., 170 revolutions per minute (rpm) for 5 days to obtain secondary seed liquid, then homogenizing the secondary seed liquid for 5 seconds (s) under aseptic conditions to obtain Coriolus versicolor seed liquid, with a mycelium content of 0.7 g/100 mL.

The embodiments use Lactobacillus plantarum (LB12, NR1-7) seed liquids prepared as follows: inoculating Lactobacillus plantarum into liquid medium (formula: peptone 10 g, beef powder 8 g, yeast powder 4 g, glucose 20 g, dipotassium hydrogen phosphate 2 g, diammonium hydrogen citrate 2 g, sodium acetate 5 g, magnesium sulfate 0.2 g, manganese sulfate 0.04 g, Tween-80 1 g, water 1,000 mL) for culture of 18 h for activation, where the Lactobacillus plantarum LB12 and NR1-7 preserved in glycerol are inoculated in an amount of 1 weight percentage (wt %) of the liquid medium; inoculating the activated seed liquid into a solid culture medium (formula: peptone 10 g, beef powder 8 g, yeast powder 4 g, glucose 20 g, dipotassium hydrogen phosphate 2 g, diammonium hydrogen citrate 2 g, sodium acetate 5 g, magnesium sulfate g, manganese sulfate 0.04 g, tween-80 1 g, agar 20 g and water 1,000 mL) for secondary activation, picking a single colony on the solid culture medium in MRS broth medium for incubation at 37° C. for 18 h after the culture is completed, then obtaining Lactobacillus plantarum seed liquid.

The embodiments also use seed liquids of Lactobacillus pentosus (MT-4), Streptococcus thermophilus (Q-1), bifidobacteria (BZ25, BZ11), Saccharomyces cerevisiae (NJ) and aroma-producing yeast (SS), which are prepared as follows:
(1) strain activation: activating Lactobacillus pentosus and Streptococcus thermophilus in MRS medium, activating bifidobacteria in PTYG medium, and activating yeast in potato medium (containing potato powder 5.0 g/L, glucose 20.0 g/L, chloramphenicol 0.1 g/L); coating plate with normal saline after activation the strains and counting;
(2) preparation of seed liquid: centrifuging activated seed liquid at 8,000 r/min for 10 min, pouring out a supernatant, and resuspending strains with sterile normal saline, adjusting the strains to have cell number of 10⁸ CFU/mL of each strain, then obtaining the seed liquid of each strain, followed by putting it in a refrigerator for later use.

### Embodiment 1

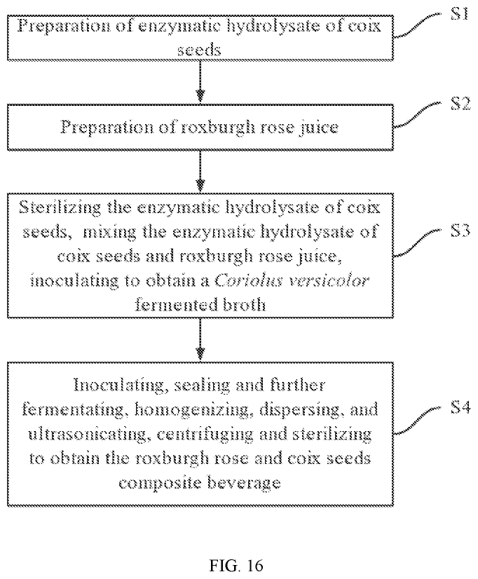

With reference to FIG. 16, a roxburgh rose and Coix seeds composite beverage prepared as the following steps:
S1, preparation of enzymatic hydrolysate of Coix seeds: washing undamaged Coix seeds three times with water and soaking the Coix seeds at 25° C. for 12 h, then pulping the Coix seeds into paste with water in a water to material ratio of 1:15, heating and gelatinizing the Coix seeds paste at 90° C. for 20 min, followed by adding enzyme for enzymolysis after complete gelatinization, including: adding high-temperature α-amylase for liquefaction, where the high-temperature α-amylase is added in an amount of 200 micrograms (U/g), the liquefaction is carried out at 90° C. for a duration of 45 min, then adding saccharifying enzyme for glycation, where the saccharifying enzyme is 300 U/g, the glycation is carried out at 65° C. for a duration of 80 min; then obtaining the enzymatic hydrolysate of Coix seeds after the enzymolysis;
S2, preparation of roxburgh rose juice: thawing frozen roxburgh rose fruits stored at −20° C. for 7 h at room temperature, then extracting the fruits with an original juicer to obtain juice, filtering the juice and storing in a brown bottle for later use;
S3, sterilizing the enzymatic hydrolysate of Coix seeds at 121° C. for 20 min and sterilizing the roxburgh rose juice at 90° C. for 20 min, mixing the enzymatic hydrolysate of Coix seeds and roxburgh rose juice after sterilizing according to a volume ratio of 7:3, obtaining a 100 mL mixture and placing it in a 250 mL conical flask, adding 6 wt % sucrose, followed by inoculating with 4 wt % Coriolus versicolor seed liquid for fermentation at 27° C. of 2 days, then obtaining a Coriolus versicolor fermented broth;
S4, respectively inoculating Lactobacillus plantarum LB12 seed liquid, Lactobacillus pentosus seed liquid, Streptococcus thermophilus seed liquid, bifidobacteria seed liquid and yeast seed liquid into Coriolus versicolor fermented broth according to an inoculation amount of 3 wt % by weight, followed by sealing and further fermentation at 37° C. for 24 h; subjecting the fermented broth to homogenizing, dispersing, and ultrasonicating for 1 h, then filtering to remove precipitate, followed by centrifuging and sterilizing to obtain the roxburgh rose and Coix seeds composite beverage, where a roxburgh rose and Coix seeds composite beverage fermented by Coriolus versicolor (marked as YZ) alone is used for comparison so as to screen strains suitable for this fermented product.

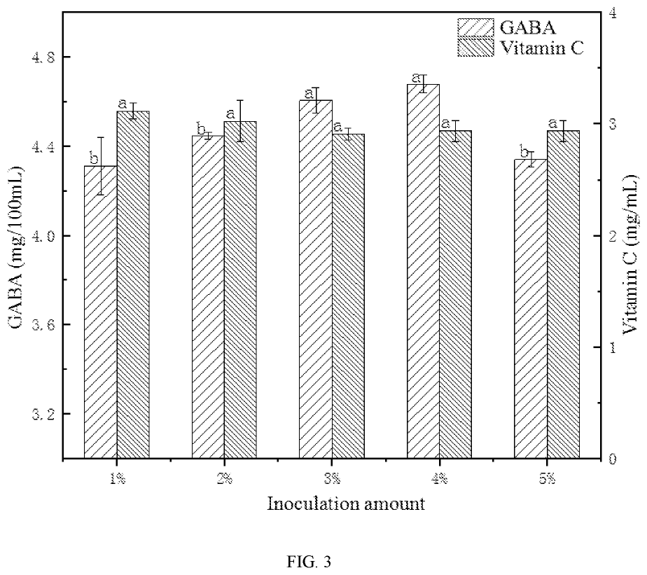

The beverages fermented by various strains are measured in terms of vitamin C content, polysaccharide content and γ-aminobutyric acid (GABA) content, and subjected to sensory evaluation as well, where the content of vitamin C is determined according to GB/T 5009.86-2016 with method of 2,6-dichloroindophenol; the content of polysaccharide is determined by phenol sulfuric acid method; and the content of GABA is determined by high performance liquid chromatography; the sensory evaluation is carried out as follows: randomly assigning blind-labeled samples to sensory evaluators, where evaluators are required to rinse mouth with clean water after each evaluation and score according to a scoring standard in Table 2; Measured results of vitamin C, polysaccharide and GABA as well as sensory evaluation in the compound beverage fermented by each strain are shown in FIG. 3.

TABLE 2

| Score | | | | | |
|---|---|---|---|---|---|
| Sensory | | | | | |
| attributes | Color and lustre | Aroma | Sweetness/sourness | Taste | Acceptability |
| 5 | Good and uniform | Rich aroma, obvious | Moderately | Rich taste, obvious | Very |
| | color, bright | aroma of roxburgh rose | sweet and sour | aroma of roxburgh | satisfied, |
| | yellow of roxburgh | and coix seeds, unique | | rose fruit and rice, | acceptable |
| | rose juice. | fermented flavor, and | | soft and harmonious | |
| | | harmonious overall | | fermentation taste, | |
| | | smell. | | silky and delicate | |
| | | | | taste, long and | |
| | | | | soft aftertaste. | |
| 4 | Relatively good | Aroma slightly | Slightly sweet | Rich taste, aroma of | Satisfied, |
| | and uniform color, | lightened, slightly | or slightly sour | roxburgh rose fruit | acceptable |
| | bright and | lighter roxburgh rose | juice, relatively | and rice, harmonious | |
| | light yellow. | fruit and rice aroma, | appropriate | fermentation flavor, | |
| | | harmonious overall | | silky and delicate | |
| | | fermentation flavor. | | taste, appropriate and | |
| | | | | soft aftertaste. | |
| 3 | The color becomes | The aroma of roxburgh | Fruit juice is | The taste is slightly | Generally |
| | dark to dark yellow, | rose or coix seeds is | slightly sweet. | lighter, the aroma of | acceptable. |
| | and the color is | heavy, and the overall | | roxburgh rose and coix | |
| | slightly turbid | fermentation flavor is | | seed is lighter, the | |
| | | relatively harmonious. | | fermentation taste is | |
| | | | | relatively harmonious, | |
| | | | | with short aftertaste. | |
| 2 | The color is yellow | The flavor is single, | Slightly sour | Light taste, heavy | Unacceptable |
| | and white, and the | and the fermentation | juice | fermentation flavor | |
| | color is slightly | flavor is not strong. | | and short aftertaste. | |
| | turbid | | | | |
| 1 | White and turbid | The aroma is light and | The juice is sour. | The taste is light and | Very |
| | in color. | impure, and the overall | | impure, the fermentation | unacceptable |
| | | smell is not harmonious. | | taste is heavy, and the | |
| | | | | overall taste is not | |
| | | | | harmonious. | |

TABLE 3

| | Vitamin C | Polysaccharide | | GABA |
|---|---|---|---|---|
| Strain | (mg/mL) | (mg/mL) | sensory score | (mg/100 mL) |
| MT-4 | 3.31 ± 0.102^{ab} | 1.39 ± 0.021^{c} | 74.16 ± 0.770^{ab} | 3.65 ± 0.187^{ab} |
| BZ25 | 3.39 ± 0.108^{ab} | 1.69 ± 0.017^{b} | 76.48 ± 0.610^{ab} | 3.39 ± 0.086^{ab} |
| BZ11 | 3.28 ± 0.076^{ab} | 1.86 ± 0.164^{a} | 79.08 ± 0.572^{a} | 3.27 ± 0.4731^{b} |
| NR1-7 | 3.41 ± 0.189^{ab} | 1.49 ± 0.011^{c} | 72.60 ± 0.427^{ab} | 3.85 ± 0.100^{a} |
| LB12 | 3.31 ± 0.086^{ab} | 1.91 ± 0.019^{a} | 81.32 ± 0.627^{a} | 3.69 ± 0.081^{ab} |
| NJ | 3.19 ± 0.066^{b} | 1.13 ± 0.013^{d} | 63.76 ± 0.720^{b} | 0.67 ± 0.023^{c} |
| SS | 3.17 ± 0.072^{b} | 1.03 ± 0.021^{d} | 63.68 ± 0.810^{b} | 0.65 ± 0.011^{c} |
| Q-1 | 3.37 ± 0.150^{ab} | 1.89 ± 0.013^{a} | 80.80 ± 0.559^{a} | 3.62 ± 0.365^{ab} |
| YZ | 3.56 ± 0.165^{a} | 1.40 ± 0.023^{c} | 78.80 ± 0.490^{a} | 3.30 ± 0.096^{b} |

Note:
means with different lower case letters in the same row indicate a significant difference (p < 0.05).

From Table 3, it can be seen that the fermentation effect of LB12 is better considering the contents of vitamin C, polysaccharide and GABA in addition to sensory score, so this strain is used for subsequent fermentation.

### Embodiment 2

Single factor experiment is conducted to investigate the effect of LB12 of different inoculation amounts (1 wt %, 2 wt %, 3 wt %, 4 wt %, 5 wt %) on the fermented beverage of Coix seeds and roxburgh rose.

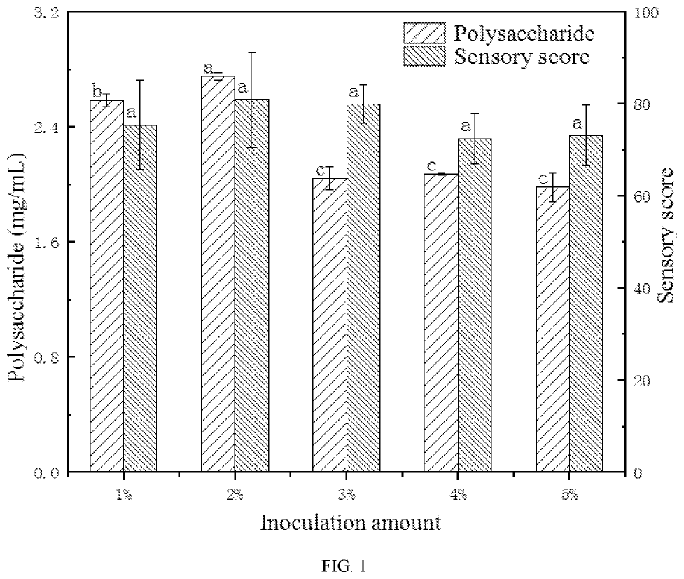

The present embodiment prepares roxburgh rose and Coix seeds composite beverages with difference from the Embodiment 1 in that the step (4) of the present embodiment includes: inoculating Lactobacillus plantarum LB12 seed liquid into the Coriolus versicolor fermented broths according to the inoculation amounts of 1 wt %, 2 wt %, 3 wt %, 4 wt % and 5 wt % (respectively corresponding to 1%, 2%, 3%, 4% and 5% in FIGS. 1 to 3), followed by sealing and further fermentation at 37° C. for 24 h; subjecting the fermented broths to homogenizing, dispersing, and ultrasonicating for 1 h, then filtering to remove precipitate, followed by centrifuging and sterilizing to obtain the roxburgh rose and Coix seeds composite beverages.

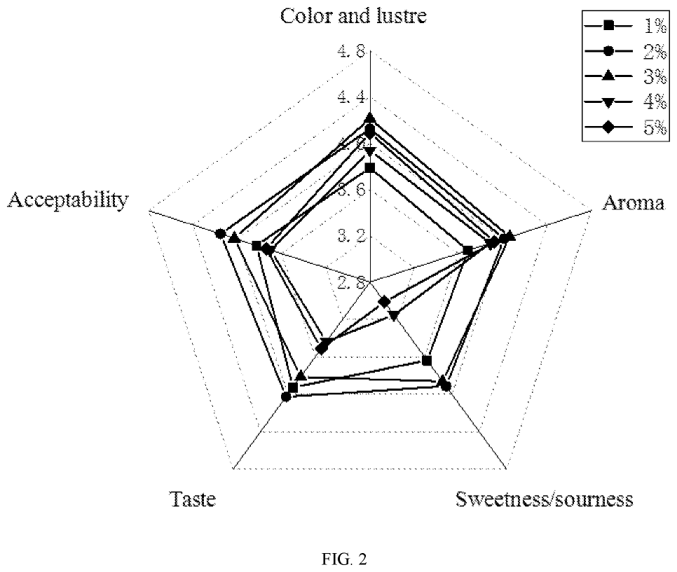

See FIG. 1 for the results of polysaccharide content and sensory score, FIG. 2 for the sensory attributes, FIG. 3 for the GABA and vitamin C contents of roxburgh rose and Coix seeds composite beverages obtained with different inoculation amounts, and 2 wt % is selected as the best inoculation amount after comprehensive consideration.

### Embodiment 3

Single factor experiment is conducted to investigate the effect of LB12 of different fermentation duration (12 h, 18 h, 24 h, 30 h, 36 h) on the fermented beverage of Coix seeds and roxburgh rose.

The present embodiment prepares roxburgh rose and Coix seeds composite beverages with difference from the Embodiment 1 in that the step (4) of the present embodiment includes: inoculating Lactobacillus plantarum LB12 seed liquid into the Coriolus versicolor fermented broths according to the inoculation amount of 2 wt %, followed by sealing and further fermentation at 37° C. for different durations, including 12 h, 18 h, 24 h, 30 h, and 36 h; subjecting the fermented broths to homogenizing, dispersing, and ultrasonicating for 1 h, then filtering to remove precipitate, followed by centrifuging and sterilizing to obtain the roxburgh rose and Coix seeds composite beverages.

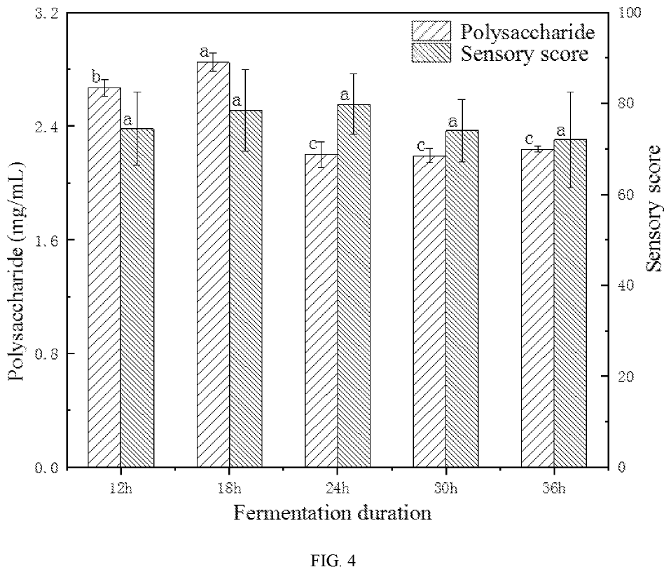

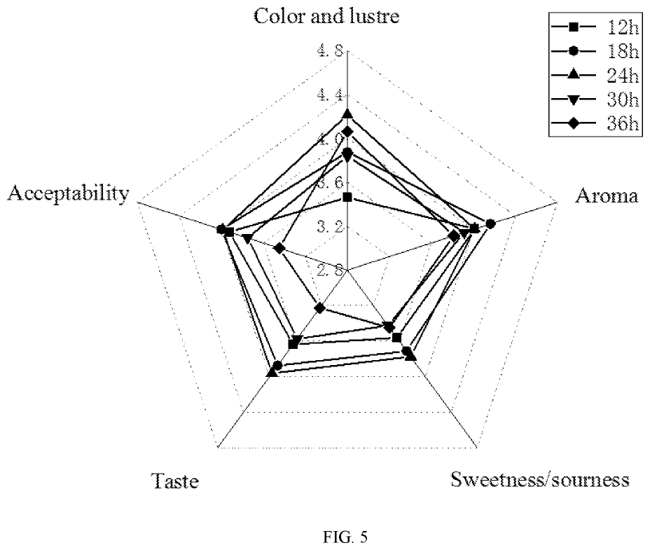

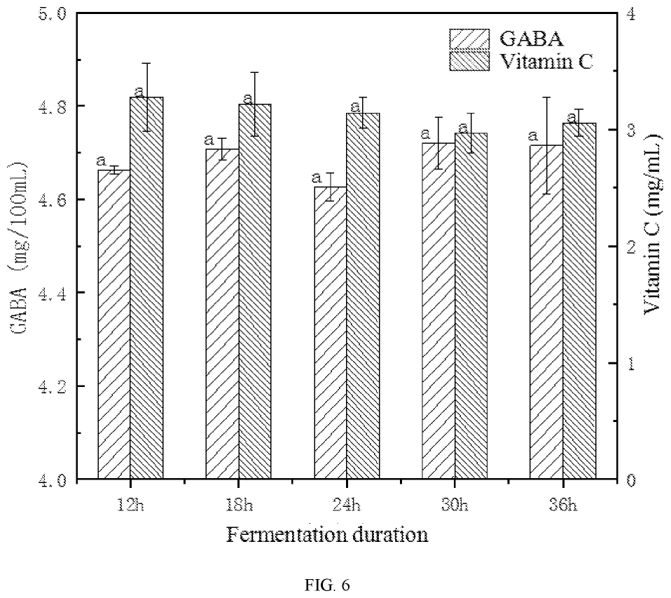

See FIG. 4 for the results of polysaccharide content and sensory score, FIG. 5 for the sensory attributes, FIG. 6 for the GABA and vitamin C contents of roxburgh rose and Coix seeds composite beverages obtained with different inoculation durations, and 18 h is selected as the best inoculation duration after comprehensive consideration.

### Embodiment 4

Single factor experiment is conducted to investigate the effect of LB12 of different fermentation temperature (29° C., 33° C., 37° C., 41° C., and 45° C.) on the fermented beverage of Coix seeds and roxburgh rose.

The present embodiment prepares roxburgh rose and Coix seeds composite beverages with difference from the Embodiment 1 in that the step (4) of the present embodiment includes: inoculating Lactobacillus plantarum LB12 seed liquid into the Coriolus versicolor fermented broths according to the inoculation amount of 2 wt %, followed by sealing and further fermentation for 18 h at 29° C., 33° C., 37° C., 41° C., 45° C. respectively; subjecting the fermented broths to homogenizing, dispersing, and ultrasonicating for 1 h, then filtering to remove precipitate, followed by centrifuging and sterilizing to obtain the roxburgh rose and Coix seeds composite beverages.

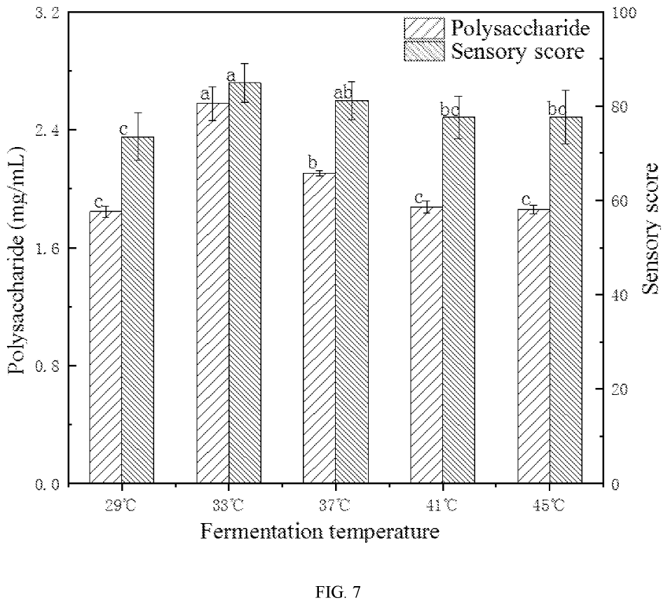

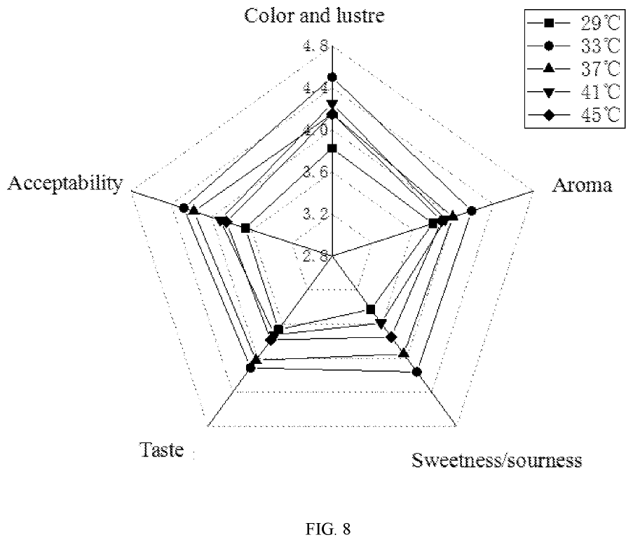

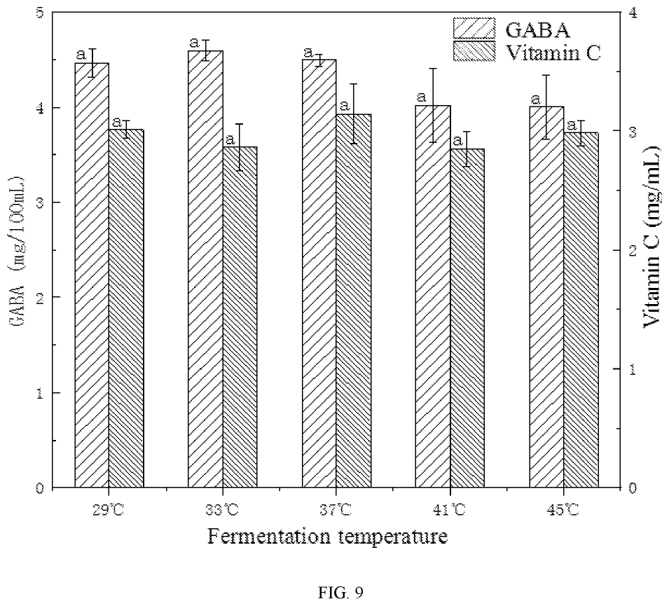

See FIG. 7 for the results of polysaccharide content and sensory score, FIG. 8 for the sensory attributes, FIG. 9 for the GABA and vitamin C contents of roxburgh rose and Coix seeds composite beverages obtained with different fermentation temperature, and 33° C. is selected as the best fermentation temperature after comprehensive consideration.

### Embodiment 5

Single factor experiment is conducted to investigate the effect of different sucrose addition (1 wt %, 3 wt %, 5 wt %, 7 wt %, 9 wt %) on the fermented beverage of Coix seeds and roxburgh rose.

The present embodiment prepares roxburgh rose and Coix seeds composite beverage with difference from the Embodiment 1 in that the step (3) of the present embodiment includes:
sterilizing the enzymatic hydrolysate of Coix seeds at 121° C. for 20 min and sterilizing the roxburgh rose juice at 90° C. for 20 min, mixing the enzymatic hydrolysate of Coix seeds and roxburgh rose juice after sterilizing according to a volume ratio of 7:3, obtaining a 100 mL mixture and placing it in a 250 mL conical flask, respectively adding sucrose of 1 wt %, 3 wt %, 5 wt %, 7 wt %, and 9 wt %, followed by inoculating with 4 wt % Coriolus versicolor seed liquid for fermentation at 27° C. of 2 days, then obtaining a Coriolus versicolor fermented broth; and
(4) respectively inoculating Lactobacillus plantarum LB12 seed liquid into the Coriolus versicolor fermented broths according to the inoculation amount of 2 wt %, followed by sealing and further fermentation at 33° C. for 18 h; subjecting the fermented broths to homogenizing, dispersing, and ultrasonicating for 1 h, then filtering to remove precipitate, followed by centrifuging and sterilizing to obtain the roxburgh rose and Coix seeds composite beverages.

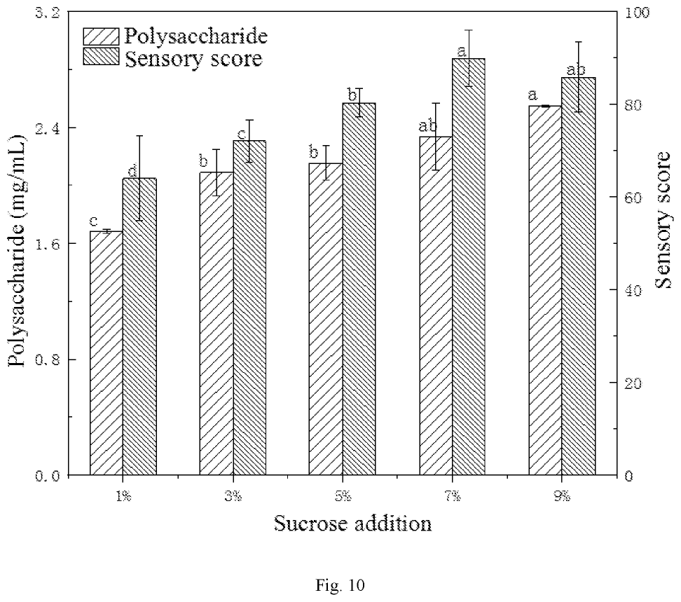

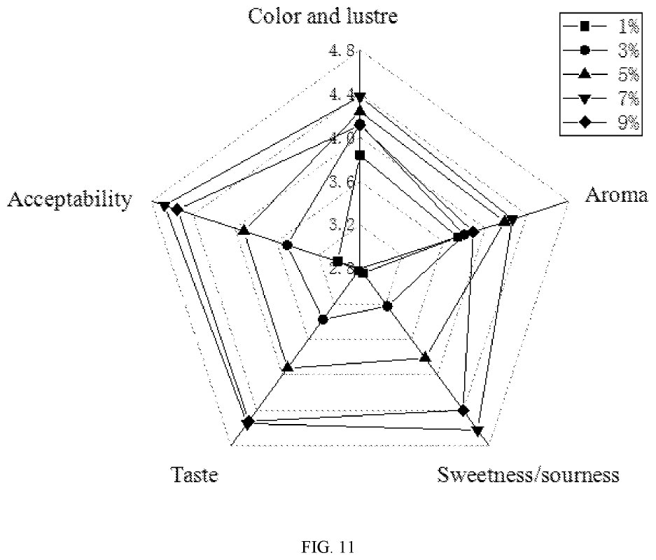

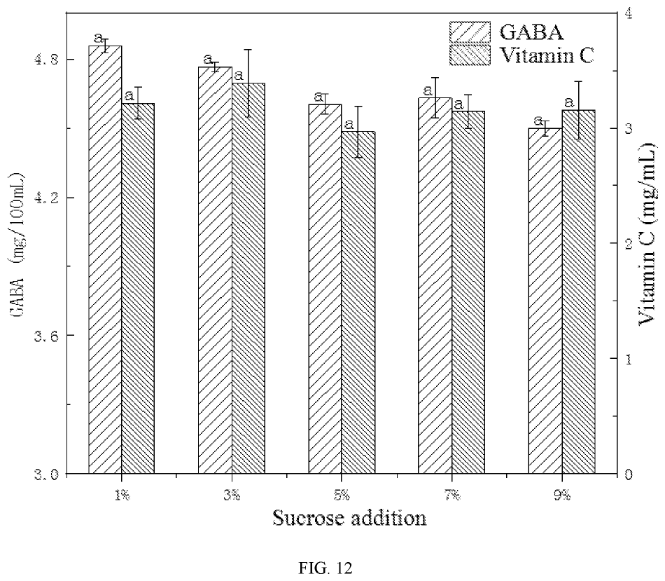

See FIG. 10 for the results of polysaccharide content and sensory score, FIG. 11 for the sensory attributes, FIG. 12 for the GABA and vitamin C contents of roxburgh rose and Coix seeds composite beverages obtained with different addition of sucrose, and 7 wt % is selected as the best addition amount after comprehensive consideration.

### Embodiment 6

Response surface methodology (RSM) is arranged to optimize four factors: fermentation duration, fermentation temperature, inoculation amount and sucrose addition amount.

The results of the single-factor experiment suggest that subsequent lactic acid bacteria fermentation has no significant effect on the content of vitamin C, so the GABA content (Y1), polysaccharide content (Y2) and sensory score (Y3) are used as response values in the response surface design, and the conditions of bacterial inoculum (A), fermentation temperature (B), fermentation duration (C) and sucrose addition (D) are selected for the four-factor, three-level response surface analysis. Table 4 shows the experimental factors and levels of the response surface experimental design, and the test results are shown in Table 5.

TABLE 4

| | level | | |
|---|---|---|---|
| | Low | | High |
| Factor | level (−1) | 0 | level (1) |
| Fermentation duration (h) | 12 | 18 | 24 |
| Fermentation temperature (° C.) | 29 | 33 | 37 |
| Bacterial inoculation amount (wt %) | 1 | 2 | 3 |
| Sucrose addition (wt %) | 5 | 7 | 9 |

TABLE 5

| | A: | B: | C: | D: | | | |
|---|---|---|---|---|---|---|---|
| | inoculation | Fermentation | fermentation | sucrose | | | |
| Test | amount | temperature | duration | addition | GABA | Polysaccharide | Sensory |
| S/N | (wt %) | (° C.) | (h) | (wt %) | (mg/100 mL) | (mg/mL) | score |
| 1 | 2 | 33 | 18 | 7 | 5.10 ± 0.108 | 2.83 ± 0.017 | 80.20 ± 2.429 |
| 2 | 1 | 33 | 24 | 7 | 4.87 ± 0.064 | 2.65 ± 0.017 | 83.15 ± 2.629 |
| 3 | 3 | 33 | 12 | 7 | 5.11 ± 0.111 | 2.60 ± 0.021 | 81.30 ± 1.966 |
| 4 | 1 | 37 | 18 | 7 | 5.11 ± 0.165 | 2.58 ± 0.019 | 85.30 ± 1.458 |
| 5 | 2 | 37 | 18 | 5 | 5.12 ± 0.025 | 2.85 ± 0.026 | 80.15 ± 1.808 |
| 6 | 2 | 33 | 18 | 7 | 5.18 ± 0.021 | 2.92 ± 0.015 | 85.05 ± 3.005 |
| 7 | 1 | 33 | 12 | 7 | 5.11 ± 0.166 | 2.61 ± 0.016 | 83.05 ± 2.693 |
| 8 | 1 | 33 | 18 | 5 | 5.32 ± 0.068 | 2.91 ± 0.024 | 77.05 ± 3.352 |
| 9 | 2 | 33 | 24 | 5 | 5.04 ± 0.043 | 2.91 ± 0.019 | 79.15 ± 2.476 |
| 10 | 2 | 37 | 18 | 9 | 4.82 ± 0.108 | 2.23 ± 0.048 | 83.10 ± 3.516 |
| 11 | 2 | 37 | 12 | 7 | 5.05 ± 0.098 | 2.58 ± 0.025 | 85.70 ± 2.731 |
| 12 | 3 | 33 | 24 | 7 | 4.96 ± 0.020 | 2.69 ± 0.014 | 83.05 ± 3.977 |
| 13 | 1 | 33 | 18 | 9 | 4.84 ± 0.099 | 2.36 ± 0.050 | 84.85 ± 3.697 |
| 14 | 2 | 33 | 18 | 7 | 4.97 ± 0.006 | 2.87 ± 0.022 | 83.00 ± 3.451 |
| 15 | 2 | 29 | 18 | 9 | 4.88 ± 0.133 | 2.56 ± 0.020 | 81.45 ± 5.115 |
| 16 | 2 | 33 | 18 | 7 | 5.13 ± 0.047 | 2.95 ± 0.023 | 84.30 ± 3.684 |
| 17 | 2 | 29 | 18 | 5 | 5.44 ± 0.112 | 2.92 ± 0.018 | 75.45 ± 2.004 |
| 18 | 3 | 33 | 18 | 9 | 4.99 ± 0.096 | 2.67 ± 0.016 | 80.85 ± 4.543 |
| 19 | 2 | 33 | 18 | 7 | 5.07 ± 0.045 | 2.89 ± 0.019 | 82.55 ± 2.347 |
| 20 | 2 | 33 | 24 | 9 | 4.60 ± 0.090 | 2.59 ± 0.012 | 87.35 ± 2.847 |
| 21 | 3 | 33 | 18 | 5 | 5.45 ± 0.173 | 2.94 ± 0.040 | 75.20 ± 5.406 |
| 22 | 2 | 37 | 24 | 7 | 4.58 ± 0.032 | 2.37 ± 0.015 | 86.05 ± 3.658 |
| 23 | 3 | 37 | 18 | 7 | 5.08 ± 0.063 | 2.6 ± 0.0250 | 84.00 ± 2.459 |
| 24 | 2 | 33 | 12 | 5 | 5.19 ± 0.082 | 2.88 ± 0.015 | 75.60 ± 3.841 |
| 25 | 2 | 33 | 12 | 9 | 4.95 ± 0.068 | 2.60 ± 0.030 | 83.95 ± 2.396 |
| 26 | 2 | 29 | 12 | 7 | 4.84 ± 0.033 | 2.22 ± 0.045 | 82.65 ± 2.890 |
| 27 | 1 | 29 | 18 | 7 | 4.87 ± 0.111 | 2.39 ± 0.019 | 75.75 ± 3.973 |
| 28 | 3 | 29 | 18 | 7 | 5.22 ± 0.096 | 2.69 ± 0.026 | 79.65 ± 3.555 |
| 29 | 2 | 29 | 24 | 7 | 4.89 ± 0.121 | 2.62 ± 0.035 | 81.90 ± 2.081 |

The analysis of variance (ANOVA) of the response value GABA is shown in Table 6. The model selected can be used to analyze the data with a good fit as the model is significant and the misfit term is not significant. The multiple regression equation of the response value GABA (Y1) on the independent variables inoculum (A), fermentation temperature (B), fermentation duration (C) and sucrose addition (D): Y1=5.09+0.058×A−0.032×B−0.11×C−0.21×D−0.096×AB−0.13×BC+0.058×A²−0.070×B²−0.16×C²+0.023×D². The interactions of the relevant variables are analyzed as shown in Table 5, and all factors interacted with each other to varying degrees, with P value=0.0033<0.01 for BC and P value=0.0228<0.05 for AB, suggesting that the interaction of BC is more significant for GABA content.

TABLE 6

| | sum of | | mean | variance | |
|---|---|---|---|---|---|
| Variance source | squares | freedom | square | ratio | P value |
| model | 1.07 | 10 | 0.11 | 17.82 | <0.0001** |
| A-inoculation amount | 0.040 | 1 | 0.040 | 6.74 | 0.0183* |
| B-fermentation temperature | 0.013 | 1 | 0.013 | 2.10 | 0.1641 |
| C-fermentation duration | 0.15 | 1 | 0.15 | 24.63 | 0.0001** |
| D-sucrose addition | 0.51 | 1 | 0.51 | 85.22 | <0.0001** |
| AB | 0.037 | 1 | 0.037 | 6.20 | 0.0228* |
| BC | 0.069 | 1 | 0.069 | 11.50 | 0.0033** |
| A² | 0.022 | 1 | 0.022 | 3.70 | 0.0705 |
| B² | 0.032 | 1 | 0.032 | 5.27 | 0.0339* |
| C² | 0.16 | 1 | 0.16 | 27.25 | <0.0001** |
| D² | 3.368E−003 | 1 | 3.368E−003 | 0.56 | 0.4633 |
| residual | 0.11 | 18 | 5.996E−003 | | |
| misfit term | 0.084 | 14 | 5.994E−003 | 1.00 | 0.5606 |
| error term | 0.024 | 4 | 6.002E−003 | | |
| total | 1.18 | 28 | | | |

The ANOVA of the response value polysaccharide is shown in Table 7; the model selected can be used to reflect the actual situation of the experiment with a good fit as the model is significant and the misfit term is not significant. Regression analysis of the experimental data is performed and the quadratic regression model with polysaccharide as the response value of the objective function is obtained as: Y2=2.89+0.057×A−0.015×B+0.029×C−0.20×D−0.072×AB+0.072×AD−0.15×BC−0.11×A²−0.25×B²−0.16×C²−0.020×D²; the interactions of the variables of interest are analyzed as shown in Table 7, and there are different degrees of interactions among the factors.

TABLE 7

| | sum of | | mean | variance | |
|---|---|---|---|---|---|
| Variance source | squares | freedom | square | ratio | P value |
| model | 1.17 | 11 | 0.11 | 13.84 | <0.0001** |
| A-inoculation amount | 0.039 | 1 | 0.039 | 5.02 | 0.0388* |
| B-fermentation temperature | 2.729E−003 | 1 | 2.729E−003 | 0.35 | 0.5593 |
| C-fermentation duration | 0.010 | 1 | 0.010 | 1.31 | 0.2676 |
| D-sucrose addition | 0.48 | 1 | 0.48 | 62.32 | <0.0001** |
| AB | 0.020 | 1 | 0.020 | 2.66 | 0.1210 |
| AD | 0.021 | 1 | 0.021 | 2.68 | 0.1200 |
| BC | 0.095 | 1 | 0.095 | 12.40 | 0.0026** |
| A² | 0.080 | 1 | 0.080 | 10.44 | 0.0049** |
| B² | 0.39 | 1 | 0.39 | 50.82 | <0.0001** |
| C² | 0.16 | 1 | 0.16 | 20.31 | 0.0003** |
| D² | 2.715E−003 | 1 | 2.715E−003 | 0.35 | 0.5603 |
| residual | 0.13 | 17 | 7.692E−003 | | |
| misfit term | 0.12 | 13 | 9.368E−003 | 4.17 | 0.0893 |
| error term | 8.990E−003 | 4 | 2.248E−003 | | |
| total | 1.30 | 28 | | | |

See FIG. 8 for the ANOVA of the response value polysaccharide, where the model is highly significant, and the misfit term is not significant, indicating a good model fit. Regression analysis of the experimental data yields a quadratic regression model for the objective function with sensory score as response values as: Y3=82.79−0.43×A+2.29×B+0.70×C+3.25×D−1.30×AB+0.41×AC−0.54×AD−1.28×A²+1.18×C²−2.41×D²; the interactions of the relevant variables analyzed as shown in Table 7 show that there are different degrees of interactions among the factors, and the P values of the interactions among the factors AB, AC, and AD are all greater than 0.05, indicating that the interactions among the factors do not have a significant effect on the sensory score, and the order of the interactions among the factors on the sensory value is AB>AD>AC.

TABLE 8

| | sum of | | mean | variance | |
|---|---|---|---|---|---|
| Variance source | squares | freedom | square | ratio | P value |
| model | 270.61 | 10 | 27.06 | 9.69 | <0.0001** |
| A-inoculation | 2.17 | 1 | 2.17 | 0.78 | 0.3900 |
| amount | | | | | |
| B-fermentation | 62.79 | 1 | 62.79 | 22.47 | 0.0002** |
| temperature | | | | | |
| C-fermentation | 5.88 | 1 | 5.88 | 2.10 | 0.1641 |
| duration | | | | | |
| D-sucrose | 126.43 | 1 | 126.43 | 45.25 | <0.0001** |
| addition | | | | | |
| AB | 6.76 | 1 | 6.76 | 2.42 | 0.1372 |
| AC | 0.68 | 1 | 0.68 | 0.24 | 0.6276 |
| AD | 1.16 | 1 | 1.16 | 0.41 | 0.5283 |
| A² | 11.03 | 1 | 11.03 | 3.95 | 0.0624 |
| C² | 9.40 | 1 | 9.40 | 3.36 | 0.0832 |
| D² | 39.13 | 1 | 39.13 | 0.35 | 0.0015** |
| residual | 50.29 | 18 | 2.79 | 14.01 | |
| misfit term | 36.36 | 14 | 2.60 | | 0.6966 |
| error term | 13.93 | 4 | 3.48 | 0.75 | |
| total | 320.90 | 28 | | | |

The three response values of GABA, polysaccharide and sensory values are combined to obtain the optimal response results as follows: inoculation amount of 1.63 wt %, fermentation temperature of 35.45° C., fermentation duration of 15.03 h, sucrose addition of 6.23 wt %; under this optimized conditions, the GABA content, polysaccharide content and sensory score are predicted to be 5.189 mg/100 mL, 2.85 mg/mL and 82.793 respectively. In order to verify the optimized test results on the response surface in terms of accuracy and to facilitate the experimental operation, certain revisions are made to the optimized fermentation conditions, including: inoculation amount of 1.7 wt %, fermentation temperature of 35° C., fermentation duration of 15 h, and sucrose addition of 6 wt %. Verification tests are conducted with the revised optimized conditions, and the GABA content of roxburgh rose and Coix seeds fermented beverage under these conditions is 5.123 mg/100 mL, polysaccharide content is 2.825 mg/mL, and sensory score is 82.75, which are close to the predicted values of response surface, indicating that the fermentation conditions obtained in this experiment are feasible. As carrying out the verification test with the above revised optimized conditions, the volatile compounds in the fermentation process of the composite beverage are measured by solid-phase microextraction-gas chromatography/mass spectrometry, the tannin content is determined spectrophotometrically with reference to NY/T 1600-2008; and in vitro hypoglycemic capacity is measured by α-amylase activity inhibition rate and α-glucosidase activity inhibition rate. Fermentation sample selection: five fermentation samples are selected at five stages for determination, including: sample unfermented (CY0), sample fermented for 1 day with Coriolus versicolor seed solution (CY1), sample fermented for 2 days with Coriolus versicolor seed liquid (CY2), sample fermented for 8 h with Lactobacillus plantarum LB12 (R8h), and sample fermented for 15 h with Lactobacillus plantarum LB12 (R15h).

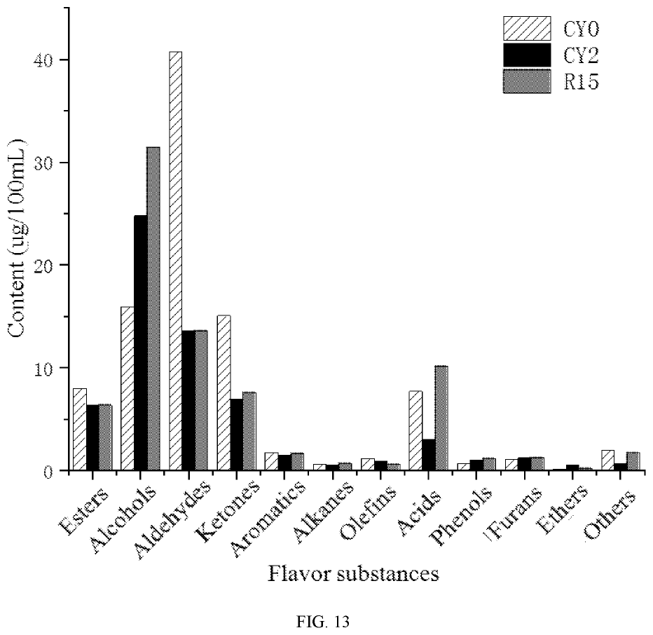

See Table 9 and FIG. 13 for the types and relative contents of volatile compounds detected at the above stages in the preparation process of roxburgh rose and Coix seeds composite beverage.

TABLE 9

| | | Fermentation stage (g/100 mL) | | |
|---|---|---|---|---|
| Compound | CAS | CY0 | CY2 | R15 |
| methyl palmitate | 112-39-0 | — | 0.086 | — |
| isoamyl acetate | 123-92-2 | 0.283 | 1.963 | — |
| ethyl acetate | 141-78-6 | 2.599 | 0.281 | 1.585 |
| leaf alcohol acetate | 3681-71-8 | 0.499 | — | — |
| etheyl octanoat | 106-32-1 | 0.149 | — | — |
| ethyl valerate | 539-82-2 | — | — | 0.023 |
| ethyl tigelate | 5837-78-5 | 0.048 | — | 1.055 |
| diethyl carbonate | 105-58-8 | 0.301 | 0.225 | — |
| dideoxy-5-methyl-γ-D-ribolactone | 91602-63-0 | 0.072 | — | — |
| diisobutyl phthalate | 84-69-5 | 0.163 | — | 0.099 |
| dibutyl phthalate | 84-74-2 | — | 0.109 | 0.102 |
| phthalic acid, 4-heptyl isobutyl ester | | — | 0.104 | — |
| phthalic acid, butyl hexyl-3-ester | | 0.175 | — | — |
| ethyl furoate | 1335-40-6 | — | — | 0.366 |
| methyl furoate | 611-13-2 | — | 1.288 | 1.042 |
| amyl formate | 638-49-3 | 0.671 | — | — |
| ethyl caproate | 123-66-0 | 0.135 | 0.094 | 0.107 |
| hexyl heptanoate | 1119-06-8 | 0.037 | — | — |
| dicarvacrol acetate | 20777-49-5 | — | — | 0.266 |
| butane-2,3-diacetate diester | 1114-92-7 | 0.331 | 0.274 | 0.301 |
| ethyl butyrate | 105-54-4 | 0.199 | — | — |
| methyl butyrate | 623-42-7 | — | 0.536 | 0.527 |
| N-amyl acrylate | 2998-23-4 | 0.107 | — | — |
| N-propyl propionate | 106-36-5 | 0.091 | 0.052 | — |
| citronellyl propionate | 141-14-0 | — | — | 0.124 |
| ethyl benzoate | 93-89-0 | 0.220 | 0.056 | 0.053 |
| methyl benzoate | 93-58-3 | — | 0.182 | 0.071 |
| γ-caprolactone | 695-06-7 | — | — | 0.117 |
| R-(−)-2-octyl-n-octyl carbonate | | — | 0.024 | — |
| 5-vinyloxy hept-6-alkenyl 2,2- | | — | — | 0.009 |
| dimethylpropionate | | | | |
| methyl 5-oxohexanoate | 13984-50-4 | 0.132 | — | — |
| 4-hydroxybutyrolactone | 96-48-0 | 1.158 | — | — |
| 3-ene lactone | 20825-71-2 | — | — | 0.086 |
| methyl 3-thiophene formate | 22913-26-4 | — | 0.335 | 0.311 |
| 3-nonene-4-lactone | 51352-68-2 | 0.079 | — | — |
| octadecyl 3-phenyl acrylate | | — | — | 0.007 |
| 2-acetyl-4,5-dimethylphenylacetate | 56537-81-6 | — | 0.020 | — |
| ethyl 2-hydroxy-3-methylbutyrate | 2441-6-7 | 0.000 | 0.002 | 0.049 |
| ethyl 2-furoate | 614-99-3 | 0.104 | 0.192 | — |
| 2-methyl-2-methyl crotonate | 41725-90-0 | — | 0.412 | — |
| ethyl 2-hexenoic acid | 1552-67-6 | 0.000 | — | — |
| methyl 14-methyl pentadecanoate | 5129-60-2 | — | — | 0.074 |
| [R,(+)]-4-hydroxycaprolactone | 63357-95-9 | 0.454 | 0.117 | — |
| (cis)-cornus officinalis diacetate | | — | 0.065 | — |
| (+−)-trans-p-menthol-1,8-diacetate | | 0.000 | — | — |
| n-octyl alcohol | 111-87-5 | 4.047 | 0.398 | 0.687 |
| n-amyl alcohol | 71-41-0 | — | 1.942 | 3.400 |
| hexyl alcohol | 111-27-3 | 0.892 | 3.286 | 4.278 |
| N-heptanol | 111-70-6 | 0.744 | — | 1.535 |
| normal butanol | 71-36-3 | — | 0.372 | 0.437 |
| isoamyl alcohol | 123-51-3 | — | 5.546 | 6.412 |
| isobutanol | 78-83-1 | — | 0.321 | — |
| ethanol | 64-17-5 | 0.403 | 4.692 | 2.914 |
| leaf alcohol | 928-96-1 | 1.334 | 1.726 | — |
| citronellol | 106-22-9 | — | 0.168 | — |
| cis-bicyclo [5.3.0] decanol | 27935-18-8 | 0.003 | — | — |
| cis-4-methylcyclohexane-3-ene-1,2-diol | | — | — | 0.013 |
| Cis-2-methyl cyclohexanol | 7443-70-1 | 4.422 | — | — |
| deca-2-methylene-5,5,8a-trimethyl- | | — | 0.226 | — |
| 1-naphthalene methanol | | | | |
| cinnamic alcohol | 104-54-1 | — | 0.047 | 0.072 |
| terpineol | | 0.008 | — | — |
| furfuryl alcohol | 98-00-0 | 1.109 | — | 2.639 |
| linalool | 78-70-6 | — | 0.929 | 0.874 |
| trans-3-hexene-1-ol | 928-97-2 | — | — | 2.183 |
| trans-(2-ethyl cyclopentyl) methanol | 36258-08-9 | — | 0.111 | 0.114 |
| P-cinnamyl alcohol | | 0.127 | — | — |
| benzyl carbinol | 60-12-8 | 0.043 | 0.153 | 0.206 |
| benzyl alcohol | 100-51-6 | 0.191 | 1.410 | 1.089 |
| eudesmol | 470-82-6 | 0.470 | — | — |
| α-terpineol | 98-55-5 | 0.118 | 0.158 | 0.152 |
| α,4-dimethylphenylbutanol | | — | 0.039 | — |
| α,2,8,8-tetramethyl-6-oxabicyclo | 66465-82-5 | — | — | 0.034 |
| [3.2.1] octan-2-en-7-ethanol | | | | |
| P-mint-4(8)-enol | 15714-11-1 | — | 1.460 | 1.562 |
| 6-Oxabicyclo [3.1.0] hexane-2,4-diol | | 0.359 | — | — |
| 4-propenyl-cyclohexyl-methanol | 22451-48-5 | — | 0.271 | — |
| 3-methylene-1-dodecanol | | — | — | 0.160 |
| 3-thiophene methanol | 71637-34-8 | 0.054 | 0.138 | — |
| 3-phenylpropanol | 122-97-4 | — | 0.596 | 0.489 |
| 2-ethyl hexanol | 104-76-7 | 0.821 | 0.490 | 0.586 |
| 2-thiophene methanol | 636-72-6 | — | — | 0.147 |
| 2-(4-methylene cyclohexyl) propenol | 29548-13-8 | 0.306 | 0.147 | 0.268 |
| 2-(1,2-epoxycyclopentyl)-5- | | — | 0.059 | — |
| (tetrahydropyran-2-yloxy)-3-pentynol | | | | |
| 1-octene-3-ol | 3391-86-4 | 0.467 | — | 0.425 |
| 1-nonanol | 143-08-8 | 0.047 | 0.087 | 0.296 |
| (white alcohol) decahydro-2-methylene- | | — | — | 0.170 |
| 5,5,8a-trimethyl-1-naphthalene methanol | | | | |
| (+)-p-menth-1-ene-9-ol | 18479-68-0 | — | — | 0.266 |
| octanal | 124-13-0 | 5.984 | 0.919 | 1.790 |
| N-hexanal | 66-25-1 | 0.973 | 0.207 | 0.150 |
| isovanillin | 621-59-0 | 0.048 | — | — |
| acetaldehyde | 75-07-0 | — | — | 0.232 |
| coconut aldehyde | 104-61-0 | 0.114 | — | — |
| pentanal | 110-62-3 | 3.115 | — | — |
| salicylaldehyde | 90-02-8 | 0.145 | — | — |
| aldehyde | 112-44-7 | 1.471 | — | — |
| pentadecylaldehyde | 2765-11-9 | 0.049 | — | — |
| dodecaldehyde | 112-54-9 | 0.253 | 0.053 | 0.049 |
| nonanal | 124-19-6 | 15.623 | 4.319 | 6.451 |
| furfural | 98-01-1 | 2.454 | 0.421 | 0.549 |
| decanal | 112-31-2 | 1.306 | 1.066 | 1.274 |
| trans cinnamaldehyde | 14371-10-9 | 0.094 | — | — |
| trans-2-nonanal | 18829-56-6 | 0.211 | — | — |
| trans-2-decenal | 3913-81-3 | 2.464 | 0.341 | 0.332 |
| trans-2-octenal | 2548-87-0 | — | 0.180 | 0.176 |
| P-tert-butylbenzaldehyde | | — | — | 0.013 |
| P tolualdehyde | 104-87-0 | 0.127 | — | — |
| hyacinthin | 122-78-1 | 0.402 | 0.081 | 0.122 |
| phenyl aldehyde | 100-52-7 | 0.956 | 3.801 | — |
| 5-ethylcyclopentene-1-formaldehyde | 36431-60-4 | 0.740 | 0.060 | 0.159 |
| 4-oxo-5-heptaldehyde | | 0.011 | — | — |
| 4-hydroxy-6-methylheptaldehyde diacetal | 119702-46-4 | — | — | 0.059 |
| 4-N-propyl benzaldehyde | 28785-06-0 | 0.493 | 1.168 | 0.749 |
| 4,5-dihydrofuran-3-formaldehyde | 117632-28-7 | — | 0.066 | 0.056 |
| 3-ethylbenzaldehyde | 34246-54-3 | 0.247 | — | — |
| 3,5-dimethylbenzaldehyde | 5779-95-3 | — | 0.047 | 0.026 |
| 2-hexenal | 6728-26-3 | 0.065 | — | — |
| 2-octenal | 2363-89-5 | 0.595 | — | — |
| 2-undecenal | 2463-77-6 | 1.119 | 0.359 | 0.354 |
| 2-methylvaleraldehyde | 123-15-9 | — | — | 0.163 |
| 2-methylbenzaldehyde | 529-20-4 | 0.009 | — | — |
| 2,5-dimethylbenzaldehyde | 5779-94-2 | — | 0.242 | 0.428 |
| 2,4,5-trimethylbenzaldehyde | 5779-72-6 | 0.058 | — | — |
| 2,3-dimethylbenzaldehyde | 5779-93-1 | 0.106 | — | — |
| (E)-2-heptene aldehyde | 18829-55-5 | 1.521 | 0.276 | 0.497 |
| 2-octanone | 111-13-7 | 2.272 | — | — |
| heterocyclic undecane-2,7-dione | 4753-58-6 | — | — | 0.003 |
| geranyl acetone | 3796-70-1 | 0.244 | — | 0.099 |
| heptane-3,4-dienone | | — | 0.066 | — |
| 6 methyl 5 hepten 2 one | 110-93-0 | 0.940 | — | 0.158 |
| herbal ketone | 67801-33-6 | 0.262 | — | — |
| 5-penty1-2(5H)-furanone | | 0.160 | — | — |
| 4-octanone | 589-63-9 | 0.113 | — | 0.004 |
| 4(R*)-hydroxy-5(S*)-ethyl-4,5-dihydro-2(3H)- | | 0.124 | 0.036 | — |
| furanone | | | | |
| 3-octene-2-one | 1669-44-9 | 0.071 | — | — |
| 3-octanone | 106-68-3 | 0.214 | 0.789 | — |
| 3-hydroxy-2-butanone | 513-86-0 | — | — | 0.296 |
| 3-heptanone | 106-35-4 | 0.023 | 0.017 | — |
| 3,5,5-trimethylcyclohex-2-ene dione | | 0.006 | 0.054 | 0.059 |
| 3,4-dimethyl benzophenone | 2571-39-3 | — | — | 0.057 |
| 2-pentanone | 107-87-9 | — | — | 0.130 |
| 2-methyl spiro-decenone | | 2.648 | — | — |
| 2-methyl-3-hydroxy-4-pyrone | 118-71-8 | 0.007 | — | — |
| 2-heptanone | 110-43-0 | 1.298 | — | — |
| 2H-pyran-2,6(3H)-dione | 5926-95-4 | 0.837 | 2.162 | 2.854 |
| 2,5-dimethyl-4-methoxy-3(2H)-furanone | 4077-47-8 | 3.768 | 3.407 | 3.603 |
| 2,4-dimethyl acetophenone | 89-74-7 | 0.041 | 0.043 | — |
| 2,3-octanedione | 585-25-1 | 1.521 | — | — |
| 2(5H)-furanone | 497-23-4 | 0.428 | 0.357 | 0.364 |
| 1-phenyl-5-ethyl-3,4-dienone | 113486-21-8 | 0.018 | — | — |
| 1-(2-methyl-1-cyclopentenyl) ethanone | 3168-90-9 | 0.045 | — | 0.005 |
| 1-(2-fury1)-2-hydroxy-ethanone | 17678-19-2 | 0.040 | 0.041 | — |
| 1-(2,2,3-trimethylcyclopent-3-alkeny1) acetone | 26585-75-1 | — | 0.013 | — |
| cumene | | — | 0.005 | — |
| ethylbenzene | 100-41-4 | — | — | 0.169 |
| trimethylbenzene | 25551-13-7 | 0.038 | — | — |
| ortho-xylene | 95-47-6 | 0.282 | 0.262 | 0.366 |
| elemicin/5-allyl-1,2,3-trimethoxybenzene | 487-11-6 | 0.081 | 0.109 | 0.111 |
| m-Xylene | 108-38-3 | — | — | 0.171 |
| toluene | 108-88-3 | 1.236 | 1.048 | 0.704 |
| para-xylene | 106-42-3 | — | 0.073 | — |
| 1-methyl-4-(1-methylvinyl) benzene | 1195-32-0 | 0.032 | — | 0.089 |
| 1-methyl-2-propyl-1-alkynyl benzene | 57497-13-9 | 0.112 | — | — |
| 1,2,4,5-Tetratoluene | 95-93-2 | — | 0.002 | 0.025 |
| 1,2,3-trimethylbenzene | 526-73-8 | — | — | 0.017 |
| 1,2,3,5-tetramethylbenzene | 527-53-7 | 0.010 | — | — |
| aromatics | | 7(1.791) | 6(1.498) | 8(1.653) |
| hendecane | 1120-21-4 | 0.361 | 0.353 | 0.438 |
| pentadecane | 629-62-9 | 0.018 | — | — |
| decane | 124-18-5 | — | 0.021 | 0.039 |
| 6-methyl-dodecane | 6044-71-9 | 0.250 | — | — |
| 5-methyl undecane | 1632-70-8 | — | — | 0.050 |
| 4-methyl decane | 2847-72-5 | — | — | 0.011 |
| 1,1′-oxo-dicyclohexane | 4645-15-2 | — | 0.010 | — |
| 1,1-bis(p-tolyl) ethane | | 0.002 | 0.033 | 0.065 |
| 1,1-dimethyl-3-methylene cyclopentane | 78343-76-7 | — | 0.123 | — |
| 7-ethyl-5-methyl-6,8-dioxane-octane | 20290-99-7 | — | — | 0.103 |
| 5,9-dimethylpentadecane | | — | — | 0.003 |
| myrcene | 123-35-3 | — | 0.074 | 0.104 |
| limonene | 138-86-3 | 0.001 | — | — |
| Styrene/cinnamene | 100-42-5 | — | 0.123 | 0.224 |
| α-Luteolene | 6753-98-6 | 0.075 | — | — |
| 4-ethyl-2-methylhexa-2,3-diene | 17530-19-7 | 0.076 | — | — |
| 3-methylstyrene | 100-80-1 | — | 0.271 | — |
| 3,5-dimethyl-1-heptyne-3-ene | | 0.414 | — | — |
| 2-methylstyrene | 611-15-4 | 0.229 | — | 0.323 |
| 2-1,3-dioxolane-1-2-furan ethylene | | — | 0.002 | — |
| 1-methoxymethyl-3,4-dimethylcyclohex-3-ene | 87412-53-1 | 0.262 | — | — |
| 1,4-Hexadiene | 592-45-0 | 0.140 | — | — |
| 1,3,7,7-tetramethyl-2-oxo-bicyclo (4.4.0) decene | 54382-45-5 | — | 0.156 | — |
| 1,3,5-undectriene | 19883-27-3 | — | 0.169 | — |
| (Z)-1-methoxy-2-methyl-2-pentene | | — | 0.176 | — |
| 1-(2-hydroxyethyl)-3-propyl-1,5-hexadiene | | 0.001 | — | — |
| N-hexanoic acid | 142-62-1 | 2.653 | 0.225 | 0.186 |
| oleic acid | 112-80-1 | 0.238 | — | — |
| isovanillic acid | 645-08-9 | — | 0.039 | — |
| isovaleric acid | 503-74-2 | — | — | 2.202 |
| acetic acid | 64-19-7 | 1.952 | 0.666 | 5.961 |
| caprylic acid | 124-07-2 | 1.613 | — | — |
| pelargonic acid | 112-05-0 | 0.862 | 0.446 | 0.541 |
| enanthic/heptylic acid | 111-14-8 | 0.266 | 0.033 | — |
| butanoic acid | 107-92-6 | 0.019 | 0.971 | 1.151 |
| propanoic acid | 79-09-4 | — | 0.046 | — |
| benzoic acid | 65-85-0 | 0.124 | 0.123 | 0.137 |
| 2-methyl-propionic acid | 156564-41-9 | — | 0.501 | — |
| (E)-4,4-dimethyl-2-pentenoic acid | 101225-66-5 | — | 0.006 | — |
| phenol | 108-95-2 | 0.181 | 0.433 | 0.539 |
| 4-vinylphenol | | 0.051 | 0.087 | 0.126 |
| 4-vinyl-2-methoxyphenol | 7786-61-0 | 0.129 | 0.163 | 0.173 |
| 2,6-di-tert-butyl-p-cresol | 128-37-0 | 0.098 | 0.070 | 0.063 |
| 2,4-di-tert-butylphenol | 96-76-4 | 0.250 | 0.297 | 0.307 |
| 1-cyclopropyl-3,4-dimethoxyeugenol | | — | — | 0.029 |
| 2,5-dimethylfuran | 625-86-5 | — | 0.292 | 0.309 |
| 2-cyclohexyl-5-methyl tetrahydrofuran | | 0.063 | — | — |
| 2-methylbenzofuran | 4265-25-2 | — | 0.037 | 0.032 |
| 2-pentylfuran | 3777-69-3 | 0.246 | 0.182 | 0.243 |
| 2-acetyl furan | 1192-62-7 | 0.665 | 0.631 | 0.727 |
| 2-acetoxy-tetrahydrofuran | | — | 0.036 | — |
| α-agarofuran | 5956-12-7 | 0.173 | — | — |
| trans-2-methoxy-6-(formylmethyl) | 129732-31-6 | — | 0.091 | — |
| tetrahydrofuran | | | | |
| Ethylene glycol phenyl ether | 122-99-6 | — | 0.062 | 0.027 |
| allyl ethyl ether | 557-31-3 | — | — | 0.140 |
| glycol diglycidyl ether | | 0.160 | — | — |
| diethylene glycol diethylether | 111-90-0 | 0.001 | 0.014 | 0.014 |
| dimethyl sulfide | 75-18-3 | — | 0.510 | — |
| Phenyl propargyl ether | 13610-02-1 | — | — | 0.089 |
| edulane | 41678-29-9 | 0.726 | — | 0.109 |
| quinoline/benzopyridine | 91-22-5 | 0.062 | — | — |
| methylnaphthalene | | 0.007 | 0.008 | 0.009 |
| dimethyl sulfur | 75-18-3 | 0.980 | — | 0.696 |
| pyrazine | 290-37-9 | — | 0.022 | 0.159 |
| cyanobenzene | 100-47-0 | 0.109 | 0.015 | — |
| benzothiazole | 95-16-9 | 0.117 | 0.144 | 0.141 |
| trans-3,5,6,8a-tetrahydro-2,5,5,8a- | 41678-29-9 | — | 0.099 | — |
| tetramethyl-2H-1-benzopyran | | | | |
| N,N′-diisopropylcarbamimide 4-nitrobenzoic | 69775-58-2 | — | 0.151 | — |
| anhydride | | | | |
| cis-3,4,5,6-tetrahydro-4-methyl- | 876-17-5 | — | — | 0.404 |
| 2-(2′-methyl-1′-propenyl)-2H-pyran | | | | |
| 2-methylpyrazine | 109-08-0 | — | — | 0.245 |
| 1-Hexyne | 693-02-7 | — | 0.063 | — |
| (−)-cis-(1R,2R)-1-hydroxy-2-methylindane | | — | 0.185 | — |

From Table 9 and FIG. 13, it can be seen that 140, 124 and 125 volatile compounds are identified in composite beverage of roxburgh rose and Coix seeds before, during and after the whole fermentation, respectively. The volatile substances of the composite beverage in the unfermented stage CY0 are mainly 25 kinds of esters (8.006 g/100 mL), 20 kinds of alcohols (15.964 g/100 mL), 29 kinds of aldehydes (40.752 g/100 mL), 22 kinds of ketones (15.080 g/100 mL), 8 kinds of acids (7.727 g/100 mL), 7 aromatics (1.791 g/100 mL), 8 olefins (1.197 g/100 mL), 4 furans (1.146 g/100 mL), 4 alkanes (0.632 g/100 mL), 5 phenols (0.709 g/100 mL), 2 ethers (0.161 g/100 mL), of which the volatile compounds of aldehydes account for the most, followed by alcohols, ketones, esters and acids. In the Coriolus versicolor fermentation CY2 stage, the volatile substances of the composite beverage mainly include 21 esters (6.416 g/100 mL), 25 alcohols (24.771 g/100 mL), 17 aldehydes (13.607 g/100 mL), 11 ketones (6.985 g/100 mL), 10 acids (3.056 g/100 mL), 6 aromatics (1.498 g/100 mL), 7 olefins (0.971 g/100 mL), 6 furans (1.270 g/100 mL), 5 alkanes (0.539 g/100 mL), 5 phenols (1.049 g/100 mL) and 3 ethers (0.586 g/100 mL), among which, alcohols have the highest content of volatile compounds, followed by aldehydes, ketones, esters and acids. In the R15h stage of fermentation of Lactobacillus plantarum LB12, the volatile substances of Coix seeds and roxburgh rose composite beverage mainly include 21 esters (6.374 g/100 mL), 27 alcohols (31.407 g/100 mL), 20 aldehydes (13.629 g/100 mL), 12 ketones (7.631 g/100 mL), 6 acids (10.177 g/100 mL), 8 aromatics (1.653 g/100 mL), 3 olefins (0.651 g/100 mL), 4 furans (1.311 g/100 mL), 7 alkanes (0.708 g/100 mL), 6 phenols (1.238 g/100 mL) and 4 ethers (0.270 g/100 mL), among which he highest content of volatile compounds is found in alcohols, followed by aldehydes, acids, ketones and esters.

In the stages of CY2 and R15 after Coriolus versicolor fermentation and Lactobacillus plantarum fermentation, the contents of alcohols and acids in the volatile substances of Coix seeds and roxburgh rose composite beverage are significantly increased, while that of ketones and aldehydes are obviously reduced, providing the composite beverage a rather harmonious flavor. The volatile substances are closely related to the fermentation, which not only changes the physicochemical properties of the composite beverage, but also greatly improves the flavor and quality of the beverage.

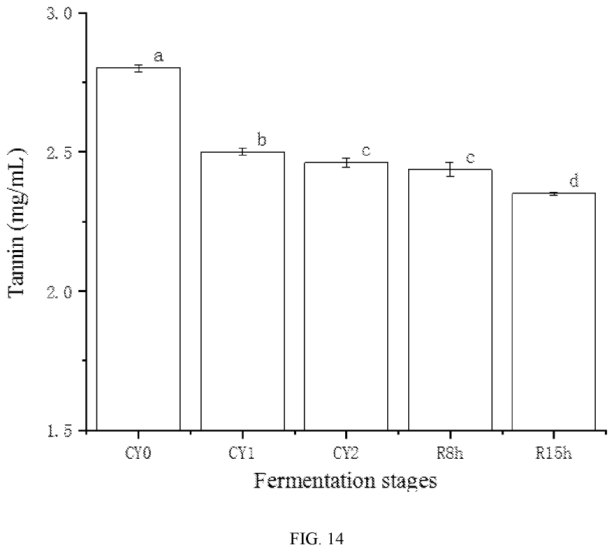

Tannin contents in the composite beverage obtained at each stage are shown in FIG. 14, from where it can be seen that the tannin content drops from 2.802 mg/mL to 2.350 mg/mL after fermentation, with an overall decrease of about 16%. Lower tannin content contributes to lower astringency and enhances the taste acceptability of the beverage.

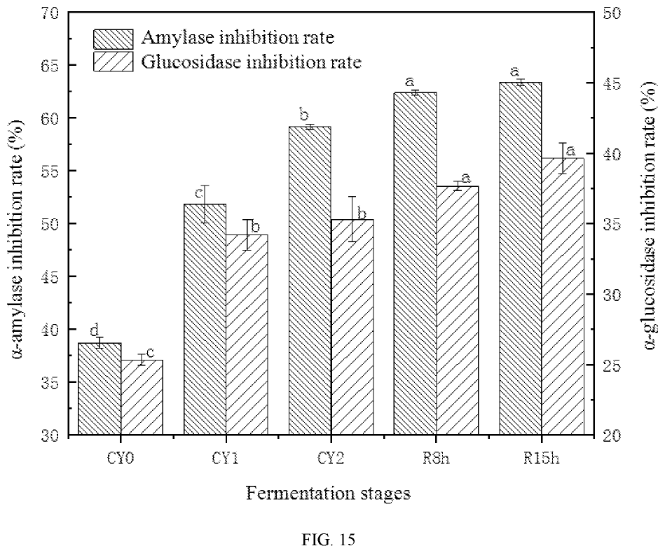

The results of in vitro hypoglycemic activity test (i.e., the inhibition rates of α-amylase and α-glucosidase) of the Coix seeds and roxburgh rose composite beverage as shown in FIG. 15 indicates that fermentation improves the inhibition rates of α-amylase and α-glucosidase of the composite beverage as well as the in vitro hypoglycemic activity of the compound beverage, which may be attributed to the increase in the content of hypoglycemic substances in the beverage due to fermentation.

The above are only the preferred embodiments of the present application, and the scope of protection of the present application is not limited thereto. Any person familiar with the technical field who makes equivalent substitution or change according to the technical scheme and inventive concept of the present application within the technical scope disclosed by the present application should be covered in the scope of protection of the present application.

What is claimed is:

1. A preparation method for preparing a roxburgh rose and Coix seeds composite beverage, comprising:
heating Coix seeds pulp for gelatinization, adding with alpha-amylase (α-amylase) for liquefaction, and then adding with saccharifying enzyme for saccharification to obtain Coix seeds enzymatic hydrolysate; mixing the Coix seeds enzymatic hydrolysate with roxburgh rose juice, and adding with sucrose to obtain fermentation substrate; then inoculating Coriolus versicolor seed liquid into the fermentation substrate for fermentation, and inoculating Lactobacillus plantarum seed liquid into the fermentation substrate for further fermentation, obtaining a fermented broth, subjecting the fermented broth to homogenizing and dispersing, ultrasonicating, filtering to remove the precipitation, centrifuging and sterilizing to obtain the roxburgh rose and Coix seeds composite beverage.

2. The preparation method according to claim 1, wherein the Coix seeds pulp contains Coix seeds to water in a mass ratio of 1:15; and the heating is carried out at 85-95 degree Celsius (° C.) for gelatinization of 15-25 minutes (min).

3. The preparation method according to claim 1, wherein the α-amylase is added in an amount of 200 micrograms (U/g); the liquefaction is carried out at 85-95° C. for a duration of 40-50 min; the saccharifying enzyme is added in an amount of 300 U/g; and the saccharification is carried out at 60-70° C. for a duration of 70-90 min.

4. The preparation method according to claim 1, wherein the Coix seeds enzymatic hydrolysate is in a volume ratio of 7:(2-4) to the roxburgh rose juice; and the sucrose added accounts for 1-9 percent (%) of that total mass of the Coix seeds enzymatic hydrolysate and the roxburgh rose juice.

5. The preparation method according to claim 1, wherein the Coriolus versicolor seed liquid is prepared as follows: inoculating Coriolus versicolor onto slant culture medium, and culturing the medium at 27° C. for 4-6 days under dark to obtain first-grade seeds; scraping 5-8 mycelia from the first-grade seeds in the slant culture medium into a second-grade seed liquid culture medium, culturing at 27° C. and 170 revolutions per minute (rpm) for 4-5 days to obtain a second-grade seed liquid; and homogenizing the second-grade seed liquid under aseptic condition for 5 seconds (s) to obtain the Coriolus versicolor seed liquid.

6. The preparation method according to claim 1, wherein the Coriolus versicolor seed liquid inoculated into the fermentation substrate accounts for 3.5-4.5 weight percentage (wt %) of the fermentation substrate, and the fermentation is carried out at 25-30° C. for a duration of 1.5-2.5 days.

7. The preparation method according to claim 1, wherein the Lactobacillus plantarum seed liquid is prepared as follows: inoculating Lactobacillus plantarum into a liquid culture medium for 18 hours (h) to obtain activated seed liquid, then inoculating the activated seed liquid into a solid culture medium for secondary activation, and selecting a single colony on the solid culture medium for liquid culture after the secondary activation to obtain the Lactobacillus plantarum seed liquid.

8. The preparation method according to claim 1, wherein the Lactobacillus plantarum seed liquid inoculated into the fermentation substrate accounts for 1-5 wt % of the fermentation substrate, and the further fermentation is carried out at 29-45° C. for a duration of 12-36 h.

9. The preparation method according to claim 1, wherein the mycelia in the Coriolus versicolor seed liquid is in an amount of 0.5-1 g/100 milliliters (mL); and the Lactobacillus plantarum seed liquid contains beneficial viable bacteria in a concentration of (1-9)*10 8 colony-forming unit per milliliter (CFU/mL).

10. A roxburgh rose and Coix seeds composite beverage prepared according to the preparation method of claim 1.
